(19) United States
(12) Patent Application Publication
(10) Pub. No.: US 2006/0137716 A1
(43) Pub. Date: Jun. 29, 2006

(54) Water treatment device for an article washer

(76) Inventor: Gregory Earl Gault, Greenville, NC (US)

Correspondence Address: PEARNE & GORDON LLP, 1801 EAST 9TH STREET, SUITE 1200, CLEVELAND, OH, 44114-3108, US

(21) Appl. No.: 11/287,173

(22) Filed: Nov. 23, 2005

Related U.S. Application Data
(60) Provisional application No. 60/630,668, filed on Nov. 24, 2004.

(51) Int. Cl. B08B 9/20; B08B 3/00; B08B 3/04

(52) U.S. Cl. 134/10; 134/104.2; 134/104.3; 134/104.4; 134/56 D; 134/25.1

(57) ABSTRACT

A water treatment device for an article washer is configured to selectively treat a water supply for an article washer. In one example, the water treatment device can selectively pretreat a water supply for an article washer for subsequent introduction of the treated water into the wash area of a cabinet of the article washer. In another example, an article washer includes a cartridge configured to selectively treat a water supply for the article washer. The cartridge is configured to be removably coupled to a cartridge interface from outside a wash area while a closure is positioned to close an entrance to the wash area. Methods of cleaning articles are also provided.

### CROSS-REFERENCE TO RELATED APPLICATION

This application claims the benefit of U.S. Provisional Application No. 60/630,668, filed Nov. 24, 2004, the entire disclosure which is herein incorporated by reference.

### FIELD OF THE INVENTION

The present invention relates to water treatment devices, and more particularly, to water treatment devices for an article washer.

### BACKGROUND OF THE INVENTION

Dishwashers are widely known for automatic washing, rinsing and drying of kitchenware such as utensils, pots, pans, dishes, plates, glasses and the like. In operation, soiled kitchenware may be loaded on one or more dishwasher racks. Once loaded with kitchenware, the dishwasher is charged with dishwasher detergent and the access opening to the dishwasher is closed in a water-tight fashion. The dishwasher is activated by the operator wherein the dishwasher proceeds through several cycles including at least a wash cycle and a rinse cycle. During the wash cycle, dishwashing detergent is mixed with a quantity of water and sprayed against the kitchenware to remove organic deposits and sanitize the kitchenware. After the wash cycle is complete, a rinse cycle is carried out wherein fresh tap water is typically used to rinse debris and/or dishwashing detergent residue from kitchenware. Once the rinse cycle is complete, the kitchenware is permitted to drip dry on the dishwasher rack. Alternatively, or in addition, a heating element may be energized to expedite the drying process.

Known dishwasher designs have proven to be effective for various applications. However, using tap water during the rinse cycle may leave undesirable residual material on the kitchenware. For example, minerals causing hard water spots may be deposited on the kitchenware. In addition, certain residual materials may be harmful. For example, lead, chlorine, cysts, herbicides, pesticides, bacteria, viruses, asbestos and the like might also be deposited on the kitchenware. It will be appreciated that such residual materials might contribute to an unhealthy condition if one or more of the residual materials are subsequently ingested or asperated by handling or using the contaminated kitchenware.

There is continuing need to provide article washers, such as dishwashers, and features for article washer to further simplify the process of washing articles (e.g., dishes), enhance the functionality of the article washer, improve sanitization of washed articles and/or improve the appearance of the articles, (e.g., kitchenware) processed by the article washer.

### SUMMARY OF THE INVENTION

In accordance with one aspect, the present invention provides a water treatment device for an article washer. The water treatment device includes a housing defining an interior area and a cartridge configured to be removably received by the interior area of the housing. The cartridge comprises at least one component including a first component configured to selectively pretreat a water supply for an article washer. The water treatment device further includes a switch allowing the water treatment device to selectively operate in at least a first mode of operation and a second mode of operation. The first mode of operation prevents at least one component of the cartridge from pretreating a water supply for an article washer and the second mode of operation allows at least the first component of the cartridge to pretreat a water supply for an article washer.

In accordance with another aspect, the present invention provides an article washer comprising a cabinet including a wash area, an entrance for inserting articles into the wash area, and a cartridge interface. The article washer further comprises a closure configured to selectively close the entrance and a cartridge configured to selectively treat a water supply for the article washer. The cartridge is configured to be removably coupled to the cartridge interface from outside the wash area while the closure is positioned to close the entrance.

In accordance with a further aspect, the present invention provides an article washer including a cabinet with a wash area for receiving water from a water supply for the article washer. The article washer further includes a water treatment device comprising at least one component including a first component configured to selectively pretreat a water supply for an article washer for subsequent introduction of the treated water into the wash area of the cabinet. The water treatment device is configured to selectively operate in at least a first mode of operation and a second mode of operation. The first mode of operation prevents at least one component of the water treatment device from pretreating a water supply for the article washer and the second mode of operation allows at least the first component to pretreat a water supply for the article washer.

In accordance with yet another aspect, the present invention provides a method of cleaning articles with an article washer comprising a water treatment device and a cabinet including a wash area with a water supply in communication with the wash area. The method comprises the steps of introducing articles into the wash area of the cabinet, introducing a first quantity of water into the wash area, and conducting a wash cycle on the articles with the first quantity of water. The method further includes the steps of introducing a second quantity of water into the wash area and conducting a rinse cycle on the articles with the second quantity of water. The method further includes the step of applying a selected water treatment to one of the first quantity of water and the second quantity of water with the water treatment device and then subsequently introducing the corresponding treated quantity of water into the wash area.

It is to be appreciated that other, different, possibly more broad aspects are provided as other aspects of the present invention.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 depicts a partial schematic view of a dishwasher incorporating a water treatment device in accordance with one example of the present invention;

FIG. 2 depicts an enlarged front view of the watertreatment device of the dishwasher illustrated in FIG. 1;

FIG. 3 depicts a front view of the water treatment device of FIG. 2 with the cartridge removed from the housing to illustrate the interior area of the housing;

FIG. 4 depicts a partial exploded top view of the water treatment device illustrated in FIG. 2;

FIG. 5 depicts a front view of a water treatment device in accordance with another example embodiment of the present invention;

FIG. 6 depicts a front view of the water treatment device of FIG. 5 with the cartridge removed from the housing to illustrate the interior area of the housing;

FIG. 7 depicts a partial exploded top view of the water treatment device illustrated in FIG. 5;

FIG. 8 depicts a front view of a water treatment device in accordance with another example embodiment of the present invention;

FIG. 9 depicts a front view of the water treatment device of FIG. 8 with the cartridge removed from the housing to illustrate the interior area of the housing;

FIG. 10 depicts a partial exploded top view of the water treatment device illustrated in FIG. 8; and

FIG. 11 depicts a flow diagram illustrating examples of methods of cleaning articles in accordance with aspects of the present invention.

### DESCRIPTION OF EXAMPLE EMBODIMENTS

Aspects of the invention include a water treatment device for an article washer. Various types of article washers may employ aspects of water treatment devices in accordance with the present invention. For example, article washers may comprise a washing machine for laundry. In another example, the article washer may comprise a dishwasher configured to wash kitchenware. Still further, article washers may comprise other types of washers for cleaning various types of articles.

In one aspect of the invention, filtered tap water, ratherthan unfiltered tap water, may be used to enhance functionality of the article washer. For example, use of filtered tap water for a dishwasher can improve sanitization of kitchenware and/or improve the appearance of the kitchenware processed by the dishwasher. Using filtered rinse water can reduce concentration of harmful materials such as lead, chlorine, cysts, herbicides, pesticides, viruses, bacteria, asbestos or the like. For example, it is contemplated that certain filters may be designed to remove over 99% of harmful tap water deposits such as 99.99% of bacteria, 99.29% of lead, 99.00% of asbestos and 99.99% of viruses. The above listing is exemplary in nature and it is understood that other percentage removal of harmful or potentially harmful or undesirable tap water deposits may be achieved based on the desirable outcome for the particular application. For example, any filtering whatsoever of substances from the rinse water stream may be useful to reduce or prevent water deposits on kitchenware. Various filter designs may be incorporated with the concepts of the present invention. Exemplary filters may comprise mechanical and/or chemical interaction with the tap water stream to purify the water. In particular examples, the filters may comprise a mechanical filter in addition to activated carbon material and can include exemplary filters used to purify tap water for purposes of consumption.

Providing a filtered rinse water may also enhance the functionality of existing elements of the article washer. For example, filtered rinse water in a dishwasher may eliminate grit and other hard water spots that might otherwise ruin the appearance of otherwise clean kitchenware processed by the dishwasher. Moreover, the wash agent (e.g., detergent), rinse agent, fragrance agent and/or water softener agent agent of the article washer, if used, may function better with filtered tap water than with tap water that has not been purified.

While the water treatment device for the article washer has been described with relation to a water filter for rinse water in the article washer (e.g., dishwasher), further water treatment devices may be used alternatively, or in addition to the water filter device described throughout this application. Such further water treatment devices may function, for example, to simplify the process of washing articles and/or enhance the functionality of the article washer. For example, the further water treatment device might comprise a compartment for dispensing a wash agent (e.g., detergent), a compartment for dispensing a rinse agent, a compartment for dispensing a water softening agent, and/or a compartment for dispensing a fragrance agent.

A compartment for dispensing a wash agent

may be provided to simplify the process of charging the article washer with detergent prior to each use of the article washer. A compartment for dispensing a rinse agent may also be provided to simplify the process of charging the dishwasher with a rinse agent prior to each use of the article washer. A compartment can also be provided for a water softener agent to help reduce water hardness during one or more cycles of the article washer. A compartment for dispensing a fragrance agent can also be useful to provide a pleasant odor, such as a clean smell, to the kitchen or surrounding area when opening of the dishwasher after the dishwasher is finished cycling through the dishwasher function. If charged with one or more agents described above, the article washer may have a sufficient supply of each agent to carry out one or more wash cycles without further interaction by a user.

The wash agent, rinse agent, fragrance agent and/or water softener agent compartments, if provided, may comprise a bulk material compartment adapted to dispense a dose of a bulk material comprising a respective agent during each operation of the article washer. In one example, the bulk material compartment may be of sufficient size to accommodate agent dosing for a period of 60 days of operation of the article washer although other time periods are contemplated. Moreover, means may be provided to indicate whether the bulk materal compartment requires a refill. For example, the compartment might comprise a site glass or other transparent or translucent material adapted to permit viewing of the interior area of the bulk material compartment. In other embodiments, a pressure differential may be measured to determine the level of material in the compartment.

Although not necessary, various compartments including one or more of a filter compartment, wash agent compartment, rinse agent compartment, water softener agent compartment and/or fragrance agent compartment may be incorporated as a cartridge adapted for selective removal from the dishwasher. In example embodiments, the cartridge may permit selective removal of the compartments outside the wash area of the article washer without opening the closure of the article washer. Providing the compartments as a component of a removable cartridge may simplify the process of washing articles (e.g., dishes) and/or enhance the functionality of the article washer (e.g., dishwasher) The cartridges may be reusable cartridges that can be refilled or recycled after depleting the cartridge of the particular bulk material stored therein. In further embodiments, the cartridge may be disposable, wherein the compartment is removed and discarded and thereafter replaced with a new, fully-charged cartridge.

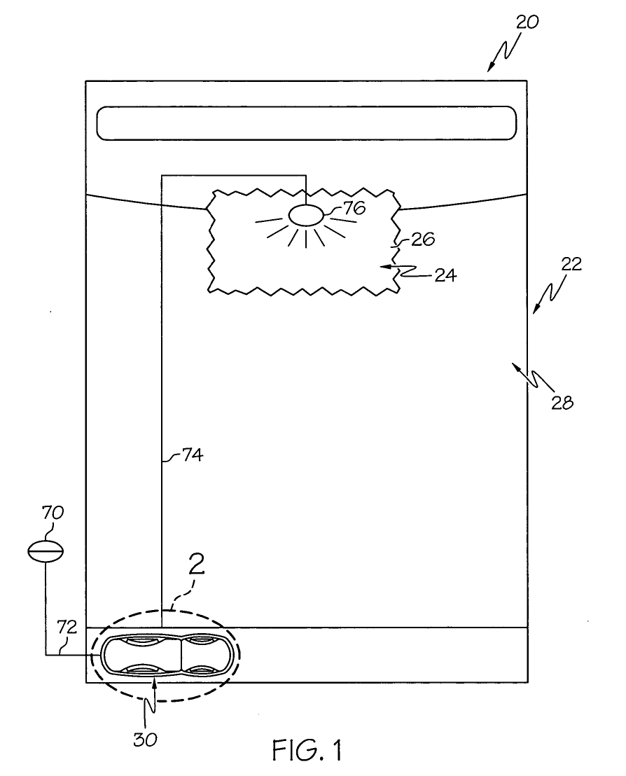

FIG. 1 depicts an example of an article washer comprising a dishwasher 20 incorporating exemplary concepts of the present invention. As shown, the dishwasher 20 can include a cabinet 22 with a wash area 24 and an entrance 26 for inserting articles

into the wash area 24 of the cabinet 22. The dishwasher 20 can also include a closure 28 configured to selectively close the entrance 26. As shown in FIG. 1, a portion of the closure 28 is broken away to illustrate a portion of the entrance 26 and a portion of the wash area 24. As shown, the entrance 26 is located at the front of the dishwasher 20. In further embodiments, it is contemplated that the entrance may be located one another side of the dishwasher and/or on a top surface of the dishwasher. Moreover, the closure 28, if provided, can comprise a wide range of shapes, sizes and configurations to selectively close the entrance 26. In the illustrated example, the closure 28 comprises a swinging door that is provided with a hinge to pivotally connect a bottom edge of the door to a lower portion of the cabinet. In order to open the door, a user simply grasps a handle to swing the door down such that it extends substantially parallel to the floor. In further examples, the door may have a lateral hinge such that the door opens to the left or right. In still further examples, the closure 28 may comprise a drawer that can translate toward and away from the cabinet to selectively close the entrance.

FIG. 1 further illustrates an example of a water treatment device 30 that may be used in accordance with aspects of the present invention. As shown, the water treatment device 30 may be mounted to permit access to the water treatment device 30 while the closure 28 is positioned to close the entrance 26. As further illustrated, the water treatment device 30 can be mounted below the closure 28 to preserve upper areas of the dishwasher for a user interface providing an informational display and/or access to more frequently used dishwasher controls. Although not shown, the water treatment device 30 can be mounted at other locations such as in the door, above the door, at a side or top of the cabinet, within the wash area of the dishwasher, or other areas of the dishwasher.

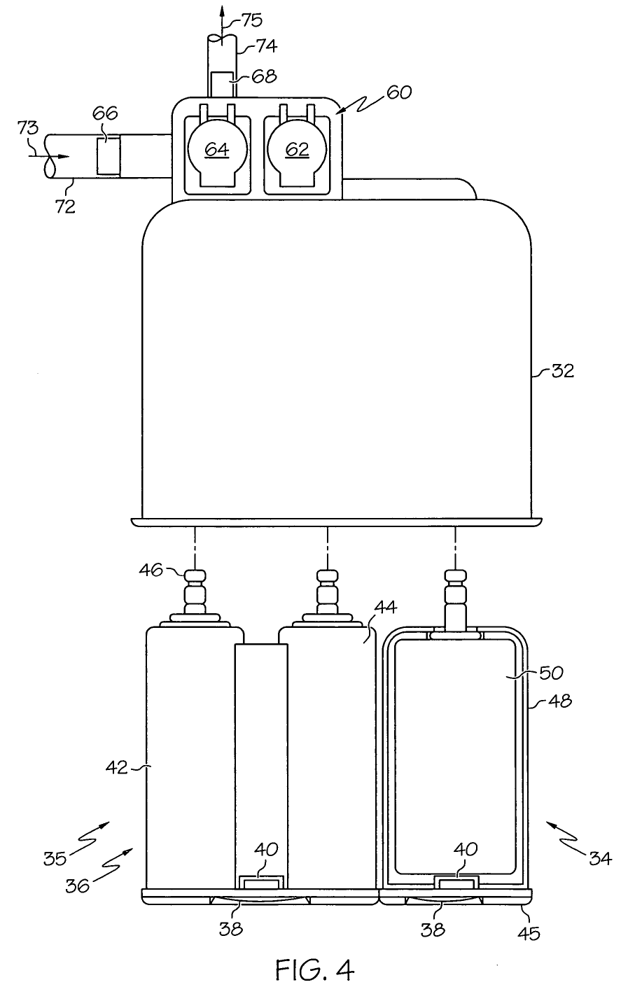

The water treatment device can be configured to pretreat a water supply for an article washer. For example, as shown in FIG. 1, a water supply 70, such as tap water in the water pipes of a house, may be provided with an inlet line 72 coupled to an inlet port 66 (see FIGS. 4) of the water treatment device. The water treatment device 30 can then selectively pretreat a quantity of water traveling in direction 73 from the inlet line 72 prior to introduction into the wash area 24 of the dishwasher 20. For example, as shown, an outlet line 74 can be coupled to an outlet port 68 to carry a pretreated quantity of water traveling in direction 75 to a spray head 76 or other liquid dispenser to dispense the pretreated quantity of water within the wash area. In further examples, the water treatment device may pretreat a quantity of water from the inlet line 72 and immediately dispense the pretreated water into the wash area 24. For example, the water treatment device may pretreat the water by treating the water as it enters into the wash area 24. The water treatment device 30 can also be configured to allow passage of a quantity of water from the inlet line 72 to the outlet line 74 without treatment.

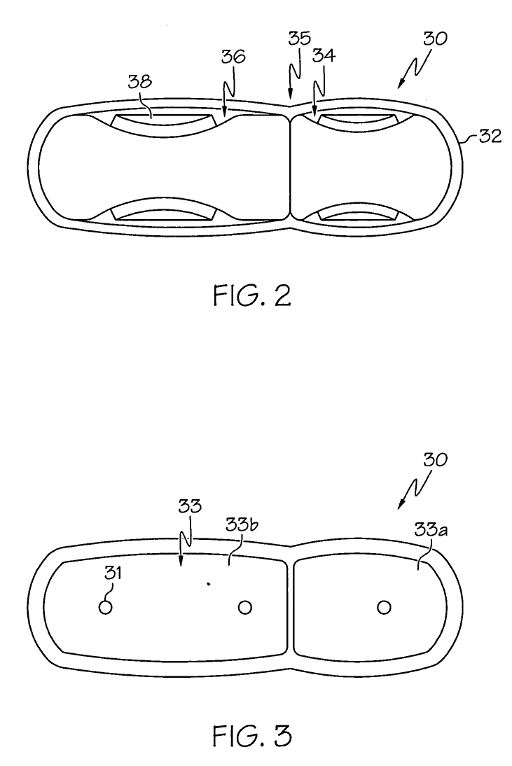

FIGS. 2-4 depict aspects of the water treatment device 30 illustrated in FIG. 1. In example embodiments, the watertreatment device 30 may have a removable cartridge although further examples including one or more nonremovable containers may be provided. As shown, the water treatment device 30 can include a housing 32 defining an interior area 33 and a cartridge 35 configured to be removably received by the interior area 33 of the housing 32. In the illustrated embodiment, the housing completely circumscribes a portion of the cartridge. In further embodiments, the housing may include one or more open sides such that the housing does not completely circumscribe the cartridge. For example, the housing may simply comprise a tray-like member to support the cartridge as it interfaces with the housing. In further examples, the cartridge may be configured to be removably coupled to an interface without a housing portion defining an interior area.

As shown in FIGS. 2 and 4, the cartridge 35 can comprise a first cartridge portion 34 and a second cartridge portion 36 that may be independently removed from respective first and second interior area portions 33a, 33b of the interior area 33. Although two cartridge portions are shown, one or more than two cartridge portions may be provided in further examples. Each cartridge portion includes at least one interface 46 configured to cooperate with a corresponding interface 31

of the housing 32. In the illustrated embodiment, the at least one interface 46 comprises a male interface and the corresponding interface 31 comprises a female interface. Although not shown, the housing can include a male interface with the cartridge portion including a corresponding female interface. In further examples, other couplings may be provided. Moreover, the couplings may be compatible with one another or may be keyed such that only a predetermined interface from one cartridge portion may be coupled with a predetermined interface from the housing. The cartridge portions can also be shaped with respect to the housing such that the corresponding cartridge portions may only be received in corresponding interior areas of the housing.

The first cartridge portion 34 comprises a single component 45 although a plurality of components may be provided in further examples. The component 45 can comprise a wide variety of shapes and sizes. In the illustrated embodiment, the component 45 comprises a container 50, such as a bottle, that is placed within a tray 48. The nipple of the bottle is illustrated extending through a slot in one end of the tray wall while the body is trapped from lateral movement by walls surrounding the bottle. In order to remove the bottle 50, the bottle may be vertically lifted out of the tray wherein the body of the bottle 50 is pulled from the area defined by the walls and the nipple of the bottle is simultaneously lifted vertically from the tray slot. Therefore, the bottle may be easily removed and replaced with a new bottle without disposing of the tray portion 48. In another example, the bottle may be removed and refilled without disposing of the tray portion 48. For example, the nipple of the bottle 50 may be removable to allow easy filling of the bottle. Once the bottle 50 is removed or replaced, the filled bottle may then inserted into the tray by dropping the body and nipple in the corresponding area defined by the walls and the tray slot. Once properly oriented, the tray 48, together with the bottle 50 may be inserted into the first interior area portion 33a of the housing 32 until the nipple appropriately engages the corresponding interface in the housing 32. Once fully inserted, the latch 40 engages the housing 32 to maintain the component 42 in place.

The second cartridge portion 36 is illustrated with a component 42 and another component 44. While two components are illustrated, the second cartridge portion may include one or more than two components. As shown, the components 42, 44 are integral with one another. Providing integral members may simplify the cartridge by minimizing the number of parts and also ensure replacement of certain components that have questionable effectiveness over time. For example, a user may forget to replace a water filter whose effectiveness typically decreases over time. By linking the water filter to an agent, such as a wash agent or other depletable agent, a user may be motivated to renew the water filter when renewing the wash agent. However, providing nonintegral members may also reduce costs to the user by allowing replacement of one component without necessitating replacement of other components. To replenish the cartridge portion 36, the components 42, 44 may be refilled or the entire cartridge portion 36 may be discarded and replaced with a new cartridge portion. Replacing the second cartridge portion 36 with a new cartridge portion may be desirable in instances where the structure within at least one of the components is difficult to refill or replace. For example, one component may comprise a water filter that is integral with the cartridge portion, rendering it difficult to replace without discarding the entire cartridge portion. On the other hand, providing refillable cartridge portions may reduce time and expense necessary to upkeep the dishwasher. One or each nipple 46 of the second cartridge portion 36 may be removable to allow refilling of one or more of the components 42, 44. In one example, a removable filter may be inserted in one of the components of the second cartridge portion 36 to allow removal and replacement of the filter without necessarily discarding the entire second cartridge portion 36. However, making the a filter integral and the agent of the remaining component nonrefillable may force renewal of the filter since the entire cartridge must be discarded and replaced. Forced renewal of the filter may be desirable to maximize dishwasher performance, and therefore enhance customer satisfaction with the dishwasher.

As shown in FIGS. 2 and 4, each cartridge portion 34, 36 can include a handle 38 and a latch 40 to facilitate removal of the cartridge portion from the housing and maintenance of a proper position between the cartridge portion and the housing. In one example, the handle can operate the latch to cause unlatching of the cartridge portion from the housing when removal of the cartridge portion is desired.

As shown in FIG. 4, the water treatment device 30 can be linked between the inlet line 72 and the outlet line 74. The water treatment device 30 can also include a switch 60. The switch can include a wide variety of structures. For example, the switch can include a mechanical and/or electrical switch. In the illustrated embodiment, the switch comprises first and second solenoid valves 62, 64 although a single or three or more valves may be provided in further examples. In one example, the solenoid valve 62 can control whether the component 44 and the component 45 pretreat a water supply. In another example, the solenoid valve 64 can control whether the component 42 pretreats a water supply. In one example, the component 44 can be configured to filter a water supply while the component 45 can be configured to pretreat the water supply by introducing a rinse agent and/or a fragrance agent to the water supply. Still further, the component 42 can be configured to pretreat the water supply by providing a wash agent to the water supply. Although three components are illustrated, any embodiment of the present invention may include a single or any plurality of components to carry out one or more treatments to a water supply. For example, the water treatment device may be configured to provide a single type of pretreatment or any plurality of pretreatments of a water supply such as: filtering, adding a wash agent, adding a rinse agent, adding a fragrance agent, adding a water softening agent, or other treatment to facilitate functioning of the article washer. Moreover, the water treatment device may be configured to provide a plurality of simultaneous treatments, may be designed to only provide a selected treatment at a particular cycle of article washer, or may be designed to allow water to pass without pretreating the water supply.

The switch 60 allows the water treatment device 30 to selectively operate in at least a first mode of operation and a second mode of operation. The first mode of operation prevents at least one component of the cartridge from pretreating a water supply for the article washer (e.g., dishwasher) and the second mode of operation allows at least the first component of the cartridge to pretreat a water supply for an article washer (e.g., dishwasher).

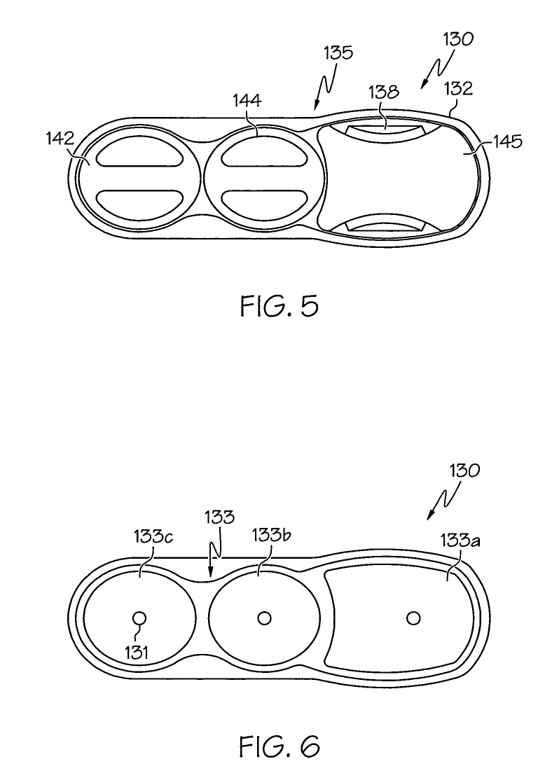

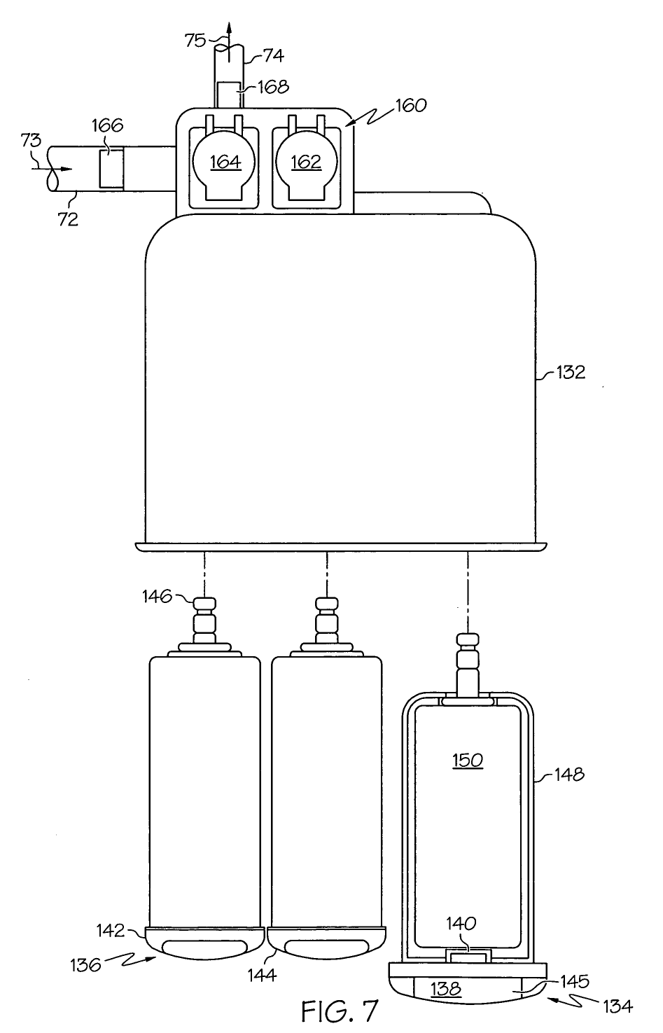

FIGS. 5-7 depict a watertreatment device 130 in accordance with another embodiment of the present invention. The water treatment device 130 and the water treatment device 30 can operate similarly or identically. Thus, the description of the water treatment device 30 above applies to the water treatment device 130 except as differentiated below. For example, the water treatment device 130 can include a housing 132 with an interior area 133. The interior area 133 includes a first interior area portion 133a, a second interior area portion 133b and a third interior area portion 133c. The water treatment device 130 includes a cartridge 135 including a first cartridge portion 134 comprising a component 145. Like the component 45, the component 145 includes a tray 148 to receive a container 150 such as a bottle. The component 45 can also include a latch 140 operable by a handle 138 to facilitate proper maintenance of the component 145 within the first ineterior area portion 133a of the housing.

The cartridge 135 further includes a second cartridge portion 136 comprising a component 142 and another component 144. The components 142, 144 are separate from another to allow replacement of one component without replacing the other component. Each component includes an interface 146 configured to cooperate with a corresponding interface 131 in the housing 132.

The illustrated water treatment device 130 also includes a switch 160 comprising first and second solenoid valves 162, 164 that can operate as discussed with respect to the valves of the switch 60 discussed above. Moreover, the water treatment device 130 can have similar inlet port 166 and outlet port 168 that operate as discussed with the ports 66,68 above.

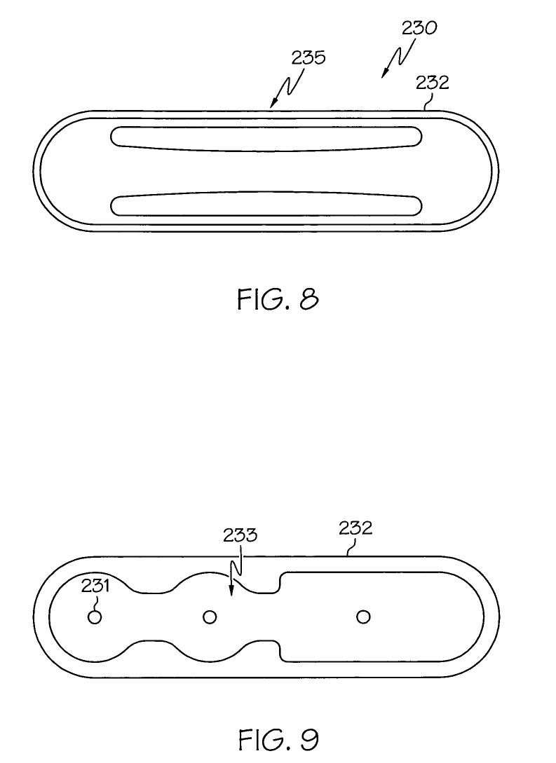

FIGS. 8-10 depict a water treatment device 230 in accordance with another embodiment of the present invention. The water treatment device 230 and the water treatment device 30 can operate similarly or identically. Thus, the description of the water treatment device 30 above applies to the water treatment device 230 except as differentiated below. For example, the water treatment device 230 can include a housing 232 with an interior area 233. The water treatment device 230 includes a cartridge 235 a single cartridge portion provided with three components 242, 244, 245 that are integral with one another. Thus, a single replaceable cartridge portion is provided that simplifies the overall cartridge construction by reducing parts and also encourages replacement of certain components, for example, that provide a filter function. Each component also includes an interface 246 configured to cooperate with a corresponding interface 231 in the housing 232. As with the components 42, 44, 45 one or more of the components 242, 244, 245 may be refillable.

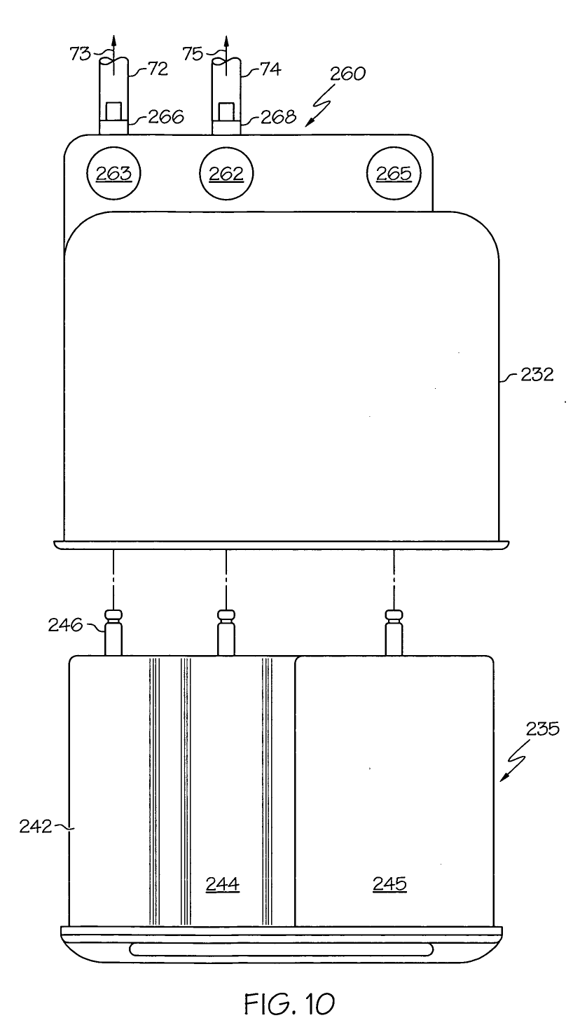

The illustrated water treatment device 230 also includes a switch 260. As discussed above, the switch of the embodiments herein can comprise two valves although structures other than valves may be employed. Moreover, if the switch 260 includes a valve structure, a single valve may be provided or, as shown with respect to the switches 60, 160, a pair of valves may be provided. It is also contemplated that more than two valves may be provided in further examples. For instance, as shown in FIG. 10, the switch 260 comprises first, second and third valves 262, 263, 265 configured to respectively control each of the three corresponding components 244, 242,245. Moreover, the water treatment device 230 can have similar inlet port 266 and outlet port 268 that operate as discussed with the ports 66,68 above.

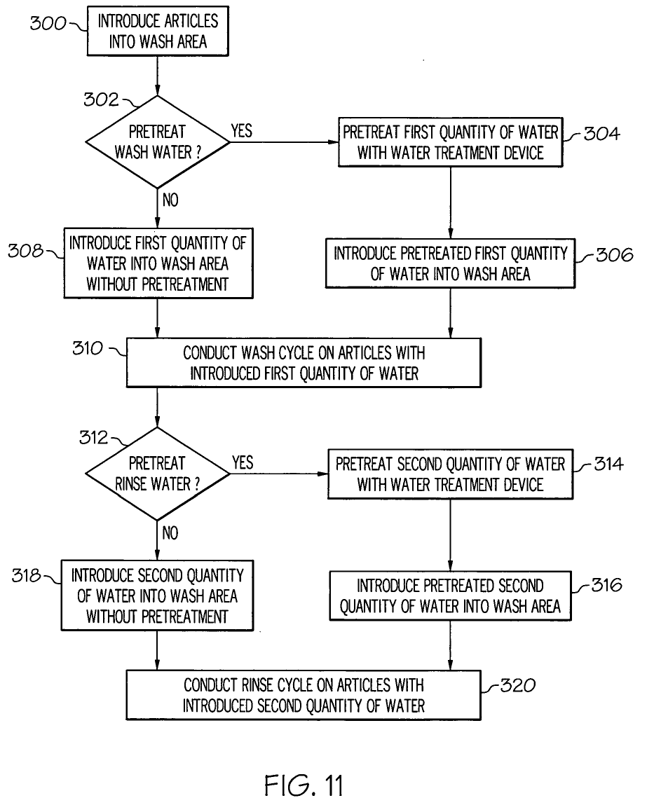

A method of cleaning articles with an article washer is described with reference to FIGS. 1 and 11. As indicated by reference numeral 300 in FIG. 11, articles to be cleaned are first introduced into the wash area 24 of the article washer (e.g., dishwasher 20).

In some examples, the wash water may not be pretreated as indicated by step 302. For example, the water treatment device may not be configured to pretreat wash water. Alternatively, a user may interface with the article washer to prevent pretreatment of the wash water. In either case, a first quantity of water is introduced into the wash area without pretreatment as indicated by step 308. Alternatively, the water treatment device may be configured to pretreat the wash water or a user may interface to cause pretreatment of the wash water. In either case, a first quantity of water is pretreated with the water treatment device as indicated by step 304. The pretreated first quantity of water is then introduced into the wash area as indicated by step 306. Once the first quantity of water is introduced into the wash area 24, the wash cycle may be conducted on the articles with the first quantity of water as indicated by step 310. Once the wash cycle is complete, the wash water may be drained from the wash area 24.

In some examples, the rinse water may not be pretreated as indicated by step 312. For example, the water treatment device may not be configured to pretreat rinse water. Alternatively, a user may interface with the article washer to prevent pretreatment of the rinse water. In either case, a second quantity of water is introduced into the wash area without pretreatment as indicated by step 318. Alternatively, the water treatment device may be configured to pretreat the rinse water or a user may interface to cause pretreatment of the rinse water. In either case, a second quantity of water is pretreated with the water treatment device as indicated by step 314. The pretreated second quantity of water is then introduced into the wash area as indicated by step 316. Once the second quantity of water is introduced into the wash area 24, the rinse cycle may be conducted on the articles with the second quantity of water as indicated by step 320. Once the rinse cycle is complete, the rinse water may be drained from the wash area 24 and the articles may be permitted to dry within the wash area.

Throughout the application, examples of the invention may treat the quantity of water by pretreating a quantity of water. In such example embodiments discussed above, pretreatment of a quantity of water is discussed to occur before introducing the pretreated quantity of water into the wash area. In some examples, this can occur by pretreating the entire quantity of water before introducing the entire pretreated quantity of water into the wash area. In further examples, this can occur by pretreating portions of the quantity of water and then adding the pretreated portions of the quantity of water into the wash area while the water treatment device continues to pretreat the remaining portions of the quantity of water for subsequent introduction into the wash area.

In certain examples, the article washer may have a mechanical or computer controller configured to operate the switch to cause appropriate functioning of the components of the water treatment device during various cycles of the dishwashing process. For instance, controller can cause the switch to activate one or more components of the water treatment device to add a wash agent to pretreat the first quantity of water for subsequent washing of articles during the wash cycle. The controller can also cause the switch to activate one or more components of the water treatment device to cause filtering or adding of a rinse agent or fragrance agent to pretreat the second quantity of water for subsequent rinsing of articles during the rinse cycle.

While a single wash agent may be used in accordance with aspects of the invention, a plurality of wash agents may also be provided. For example, one component may comprise a detergent-type wash agent while another one or more further components may also include a bleaching wash agent and/or a sanitizing wash agent. Accordingly, it is contemplated that the water treatment device may comprise a bank of components to provide increased functionality to the article washer. A user may customize the wash and rinse cycles with a user interface to control which components will be used depending on the characteristics and type of cleaning desired for the articles.

From the above description of the invention, those skilled in the art will perceive improvements, changes and modifications. Such improvements, changes and modifications within the skill of the art are intended to be covered by the appended claims.

What is claimed:

1. A water treatment device for an article washer comprising:
a housing defining an interior area;
a cartridge configured to be removably received by the interior area of the housing, the cartridge comprising at least one component including a first component configured to selectively pretreat a water supply for an article washer; and
a switch allowing the water treatment device to selectively operate in at least a first mode of operation and a second mode of operation, wherein the first mode of operation prevents at least one component of the cartridge from pretreating a water supply for an article washer and the second mode of operation allows at least the first component of the cartridge to pretreat a water supply for an article washer.

2. The water treatment device of claim 1, wherein the first component of the cartridge is configured to filter a water supply for an article washer.

3. The water treatment device of claim 1, wherein the first component of the cartridge is configured to add a washing agent to a water supply for an article washer.

4. The water treatment device of claim 1, wherein the first component of the cartridge is configured to add a fragrance agent to a water supply for an article washer.

5. The water treatment device of claim 1, wherein the at least one component of the cartridge further includes a second component configured to pretreat a water supply for an article washer.

6. The water treatment device of claim 5, wherein the at least one component of the cartridge includes a third component configured to pretreat a water supply for an article washer.

7. An article washer comprising:
a cabinet including a wash area, an entrance for inserting articles into the wash area, and a cartridge interface;
a closure configured to selectively close the entrance; and
a cartridge configured to selectively treat a water supply for the article washer, wherein the cartridge is configured to be removably coupled to the cartridge interface from outside the wash area while the closure is positioned to close the entrance.

8. The article washer of claim 7, wherein the article washer is configured to provide a wash cycle and a rinse cycle, wherein the cartridge is configured to filter a water supply for the article washer during the rinse cycle.

9. The article washer of claim 7, wherein the article washer is configured to provide a wash cycle and a rinse cycle, wherein the cartridge is configured to add a fragrance agent to a water supply for the article washer during the rinse cycle.

10. The article washer of claim 7, wherein the article washer is configured to provide a wash cycle and a rinse cycle, wherein the cartridge is configured to add a washing agent to a water supply for the article washer during the wash cycle.

11. An article washer comprising:
a cabinet including a wash area for receiving water from a water supply for the article washer; and
a water treatment device comprising at least one component including a first component configured to selectively pretreat a water supply for an article washer for subsequent introduction of the treated water into the wash area of the cabinet, wherein the water treatment device is configured to selectively operate in at least a first mode of operation and a second mode of operation, wherein the first mode of operation prevents at least one component of the water treatment device from pretreating a water supply for the article washer and the second mode of operation allows at least the first component to pretreat a water supply for the article washer.

12. The article washer of claim 11, wherein the article washer is configured to provide a wash cycle and a rinse cycle, and wherein the article washer causes the water treatment device to operate in the first mode of operation during the wash cycle and the second mode of operation during the rinse cycle.

13. The article washer of claim 12, wherein the first component is configured to filter a water supply for the article water during the rinse cycle.

14. The article washer of claim 12, wherein the first component is configured to add a fragrance agent to a water supply for the article water during the rinse cycle.

15. The article washer of claim 11, wherein the article washer is configured to provide a wash cycle and a rinse cycle, and wherein the article washer causes the water treatment device to operate in the second mode of operation during the wash cycle and the first mode of operation during the rinse cycle.

16. The article washer of claim 15, wherein the first component is configured to add a washing agent to a water supply for the article water during the wash cycle.

17. A method of cleaning articles with an article washer comprising a water treatment device and a cabinet including a wash area with a water supply in communication with the wash area, the method comprising the steps of:
introducing articles into the wash area of the cabinet;
introducing a first quantity of water into the wash area;
conducting a wash cycle on the articles with the first quantity of water;
introducing a second quantity of water into the wash area;
conducting a rinse cycle on the articles with the second quantity of water; and
applying a selected water treatment to one of the first quantity of water and the second quantity of water with the water treatment device and then subsequently introducing the corresponding treated quantity of water into the wash area.

18. The method of claim 17, wherein the selected water treatment comprises adding a washing agent to the first quantity of water prior to introducing the corresponding treated quantity of water into the wash area.

19. The method of claim 17, wherein the selected water treatment comprises adding a fragrance agent to the second quantity of water prior to introducing the corresponding treated quantity of water into the wash area.

20. The method of claim 17, wherein the selected water treatment comprises filtering the second quantity of water prior to introducing the corresponding treated quantity of water into the wash area.
